(19) United States
(12) Patent Application Publication
(10) Pub. No.: US 2013/0002343 A1
(43) Pub. Date: Jan. 3, 2013

(54) HIGH VOLTAGE REGULATION IN CHARGE PUMPS

(75) Inventors: Yanyi L. WONG, Bellevue, WA (US); Troy N. Gilliland, Bellevue, WA (US)

(73) Assignee: SYNOPSYS INC., Mountain View, CA (US)

(21) Appl. No.: 13/171,490

(22) Filed: Jun. 29, 2011

(51) Int. Cl. G05F 1/10

(52) U.S. Cl. 327/536

(57) ABSTRACT

High voltage regulation in charge pumps. A circuit includes a voltage regulator with a first input in communication with a reference voltage. The circuit also includes a data latch having a signal input coupled to receive an output of the voltage regulator and coupled to receive a clock input from a clock source. The circuit further includes a delay circuit having an input coupled to receive the clock input from the clock source. Further, the circuit includes a logic gate having a first input coupled with an output of the data latch and a second input coupled with an output of the delay circuit. Moreover, the circuit includes a charge pump having an input coupled with an output of the logic gate and an output coupled with a second input of the voltage regulator. The output of the charge pump provides an output voltage.

### TECHNICAL FIELD

Embodiments of the disclosure relate to high voltage regulation in charge pumps.

### BACKGROUND

A non-volatile memory, for example a Random Access Memory (RAM), is used as secondary storage in a computing device. The non-volatile memory typically requires high voltage to perform different operations, for example programming and erasing operations of the non-volatile memory. However, the high voltage can exceed a target voltage which can damage the non-volatile memory. Slew rate, which is defined as a rate at which the target voltage is attained, further needs to be maintained within limits for the non-volatile memory to perform accurately.

A high voltage generation system is utilized for providing regulated high voltage signals to the non-volatile memory. The high voltage generation system uses a continuous time feedback system for providing the high voltage regulation. The continuous time feedback system creates an error signal by comparing the high voltage produced at output of the charge pump with a reference voltage. The error signal is subsequently transmitted as feedback to the charge pump. The continuous time feedback system is complex in structure, design, and verification. Moreover, the continuous time feedback system is difficult to implement with the charge pump due to simultaneous high gain and phase margin requirements.

In light of the foregoing discussion, there is a need for regulating the high voltage and the slew rate of the charge pump efficiently.

### SUMMARY

Embodiments of the present disclosure described herein provide high voltage regulation in charge pumps.

A circuit includes a voltage regulator with a first input in communication with a reference voltage. The circuit also includes a data latch having a signal input coupled to receive an output of the voltage regulator and coupled to receive a clock input from a clock source. The circuit further includes a delay circuit having an input coupled to receive the clock input from the clock source. Further, the circuit includes a logic gate having a first input coupled with an output of the data latch and a second input coupled with an output of the delay circuit. Moreover, the circuit includes a charge pump having an input coupled with an output of the logic gate and an output coupled with a second input of the voltage regulator. The output of the charge pump provides an output voltage.

An example of a method of controlling a charge pump includes scaling an output voltage of the charge pump by a predetermined factor. The method also includes comparing scaled output voltage with a reference voltage to provide an error signal. The method further includes generating a gated clock signal if the error signal exceeds zero. Further, the method includes applying the gated clock signal to the charge pump.

An example of a computer program product stored on a non-transitory computer-readable medium that when executed by a processor, performs a method of controlling a charge pump includes scaling an output voltage of the charge pump by a predetermined factor. The computer program product also includes comparing scaled output voltage with a reference voltage to provide an error signal. The computer program product further includes generating a gated clock signal if the error signal exceeds zero. Further, the computer program product includes applying the gated clock signal to the charge pump.

An example of a high voltage generation system includes a charge pump that provides an output voltage to a non-volatile memory. The high voltage generation system also includes a voltage regulator with a first input in communication with a voltage reference and a second input receiving the output voltage of the charge pump. The high voltage generation system further includes a data latch receiving a signal input from an output of the voltage regulator and receiving a clock input from a clock source. Further, the high voltage generation system includes a delay circuit receiving the clock input from the clock source. Moreover, the high voltage generation system includes a logic gate with a first input receiving an output from the data latch, a second input receiving an output of the delay circuit, and an output in communication with an input of the charge pump.

### BRIEF DESCRIPTION OF THE VIEWS OF DRAWINGS

FIG. 1 is a block diagram of a high voltage generation system that enables high voltage regulation in a charge pump, in accordance with one embodiment;

FIG. 2 is a flowchart illustrating a method of functioning of a clock gating circuit, in accordance with one embodiment;

FIG. 3 is a flowchart illustrating a method of functioning of a voltage regulator, in accordance with one embodiment;

FIG. 4 is a timing diagram illustrating high voltage regulation in a charge pump, in accordance with one embodiment; and

FIG. 5 is a flow diagram illustrating a method of controlling a charge pump, in accordance with one embodiment.

### DETAILED DESCRIPTION OF THE EMBODIMENTS

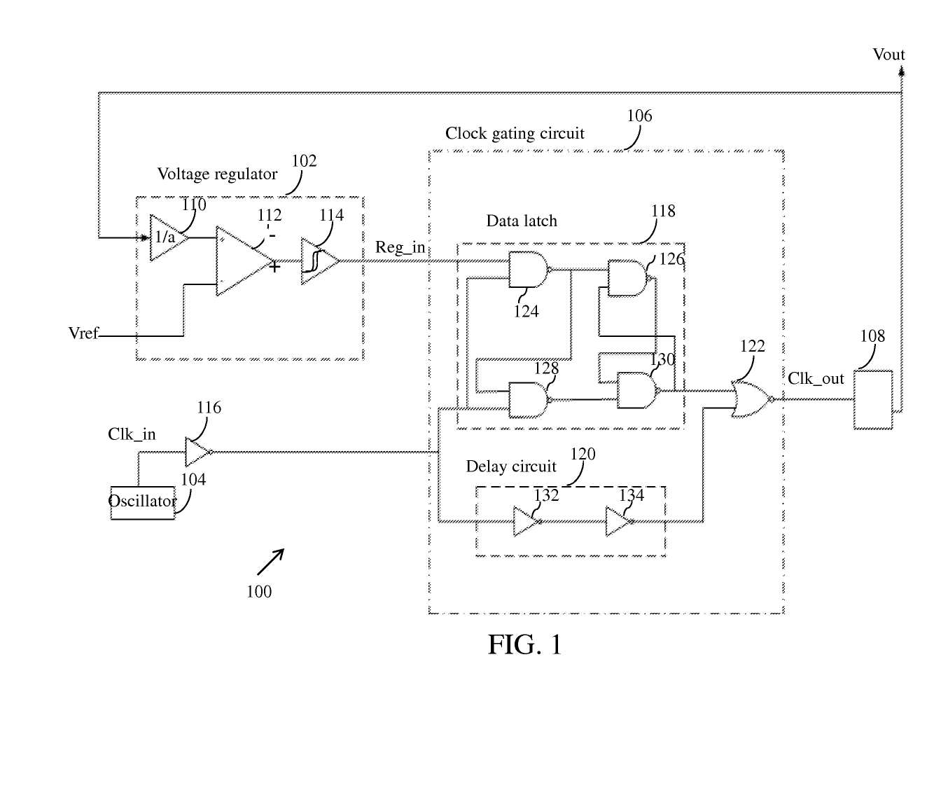

FIG. 1 is a block diagram of a high voltage generation system 100 that enables management of high voltage in a non-volatile memory, in accordance with one embodiment. The charge pump is defined as a device that uses capacitive charge storage to develop a high voltage at its output. The high voltage is used to erase or re-write non-volatile memories. The high voltage generation system 100 is a discrete time feedback system and includes a voltage regulator 102, an oscillator 104, a clock gating circuit 106, and a charge pump 108.

The voltage regulator 102 and the oscillator 104 are coupled to the clock gating circuit 106. The charge pump 108 is further coupled between the clock gating circuit 106 and the voltage regulator 102. The voltage regulator 102 includes an attenuator 110, a comparator 112 and a buffer 114 in a series connection. The clock gating circuit 106 includes a NOT gate 116, a data latch (D latch) 118, a delay circuit 120 and a NOR gate 122. The NOT gate 116 has an input coupled to the oscillator 104 and an output coupled to the delay circuit 120 and the data latch 118. The data latch 118 includes four NAND gates, for example a NAND gate 124, a NAND gate 126, a NAND gate 128 and a NAND gate 130, connected in a cross coupled configuration. The delay circuit 120 includes a NOT gate 132 and a NOT gate 134 in a series connection.

The attenuator 110 has an input in communication with the output of the charge pump 108 and an output in communication with a negative input of the comparator 112. The comparator 112 has a positive input in communication with a reference voltage. The buffer 114 is coupled between output of the comparator 112 and a first input of the NAND gate 124. A second input of the NAND gate 124 is coupled to a second input of the NAND gate 128 and to input of the NOT gate 132. Output of the NAND gate 124 is coupled to a first input of the NAND gate 128 and to a first input of the NAND gate 126. Output of the NAND gate 128 is coupled to a second input of the NAND gate 130. Output of the NAND gate 126 is coupled to a first input of the NAND gate 130. Output of the NAND gate 130 is coupled to a second input of the NAND gate 126 and to a first input of the NOR gate 122. The NOT gate 116 is coupled to input of the NOT gate 132. The NOT gate 134 is coupled between an output of the NOT gate 132 and a second input of the NOR gate 122. The NOR gate 122 further has an output coupled to input of the charge pump 108.

The voltage regulator 102 is used to compare an output voltage (Vout) of the charge pump 108 with a reference voltage (Vref). Vref can be regarded as a stable voltage, for example a band gap voltage, of the voltage regulator 102. The voltage regulator 102 compares Vout with a*Vref, which is product of a predetermined factor ‘a’ and Vref. a*Vref is also a target voltage. The target voltage can define a maximum limit of Vout. The predetermined factor ‘a’ is a multiple of Vref.

The attenuator 110, in the voltage regulator 102, attenuates or reduces amplitude of Vout. The attenuator 110 reduces Vout by the predetermined factor ‘a’ to generate an attenuated signal. The predetermined factor ‘a’ can be regarded as an attenuation factor. The predetermined factor ‘a’ also regulates slew rate. The slew rate can be defined as rate of change of voltage from the target voltage to zero. The attenuated signal is provided to the negative input of the comparator 112.

The comparator 112 compares the attenuated signal with Vref. Vref is coupled to the positive input of the comparator 112. If the attenuated signal is less than a*Vref, then the output of the comparator 112 gets connected to a supply voltage (Vdd). The clock gating circuit 106 provides pulses for increasing level of Vout of the charge pump 108. Further, if the attenuated signal is greater than a*Vref, then output of the comparator 112 gets connected to a ground voltage (Vss).

The buffer 114 is used to eliminate non-ideal behavior present in the comparator 112. In one example, the buffer 114 can be of Schmitt Trigger type or of inverter based type. If the attenuated signal is less than a*Vref by a negligible amount, the comparator 112 does not get connected to either the supply voltage Vdd or to the ground voltage Vss and can settle down to an intermediate voltage, for example Vdd/2. The Schmitt Trigger included in the buffer 114 can then be used to eliminate the possibility of output of the Schmitt Trigger settling to the intermediate voltage and further provides stability such that the output of the Schmitt Trigger gets connected to either Vdd or Vss.

The voltage regulator 102 generates an output signal referred to as Reg_in from the buffer 114 within one clock period. Reg_in is provided as input to the data latch 118. Reg_in is further used for regulating high voltage. An input signal Clk_in from the oscillator 104 is first passed through the NOT gate 116 before being provided as another input to the data latch 118.

Clk_in has a stable frequency and a duty cycle approximately equal to 50%. Clk_in can be regarded as a switch for controlling generation of Vout.

The data latch 118 is configured to replicate logic state of Reg_in at its output when Clk_in is at logic level HIGH. Further, if Clk_in is at logic level LOW then the data latch 118 retains the logic state of Reg_in, at its output, when Clk_in was logic level HIGH. Further, the output of the data latch 118 is provided as a first input to the NOR gate 122.

The delay circuit 120 including inverter gates, for example the NOT gate 132 and the NOT gate 134, is used to eliminate glitches. The glitches can be defined as disrupting signals that restrain the high voltage generation system 100 from maintaining a slew rate. Clk_in is provided as input to the delay circuit 120. Output of the delay circuit 120 is provided as a second input to the NOR gate 122. The delay circuit 120 eliminates glitches by matching delays between the first input and the second input of the NOR gate 122.

The output of the clock gating circuit 106 is a signal Clk_out. The clock gating circuit 106 generates Clk-out when Reg_in is at logic level HIGH, that is, when Vout falls below a*Vref. Thus, the clock gating circuit 106 generates Clk_out whenever the charge pump 108 requires an input voltage pulse. However, Clk_out is timed by Clk_in, such that even if Reg_in is at logic level HIGH, Clk_out can be at logic level HIGH only at a next instant of time when Clk_in is also at logic level HIGH. Hence, rate at which Clk_out pulses are generated depends on rate at which the charge pump 108 leaks charge, and on frequency of Clk_in. Further, Clk-out can be regarded as a switch that turns on the charge pump 108.

Clk_out generated by the clock gating circuit 106 is provided as input to the charge pump 108. The charge pump 108 is used to perform incrementation of voltage level at its output. The charge pump 108 uses a capacitive charge to develop Vout, which is a high voltage. Vout, provided by the charge pump 108, is used to perform different actions, for example erase, rewrite and programming actions on non-volatile memory products. The charge pump 108 further uses Clk_out to induce Vout at its output. The charge pump 108 increases Vout, by a small amount, at its output when Clk_out is at logic level HIGH. The charge pump 108 also provides Vout corresponding to the slew rate of the charge pump 108. Clk_out can be synchronized with Clk_in, thereby maintaining the slew rate of the charge pump 108.

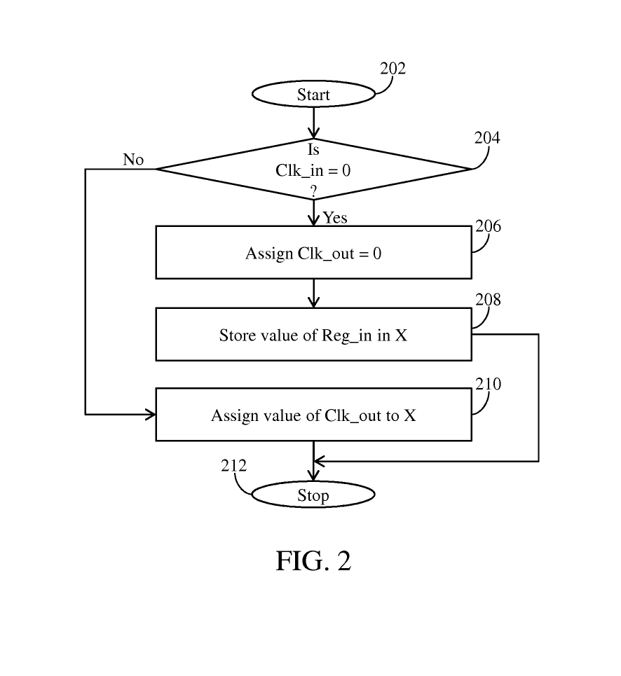

FIG. 2 is a flowchart illustrating a method of functioning of the clock gating circuit 106, in accordance with one embodiment.

The method starts at step 202.

At step 204, the clock gating circuit 106 determines if the input signal Clk_in, provided by the oscillator 104, is at logic level LOW. Clk_in at logic level LOW indicates that the output voltage Vout of the charge pump 108 has a value less than the target voltage a*Vref. If Clk_in is at logic level LOW then the method proceeds to step 206 else the method proceeds to step 210.

At step 206, the output signal Clk_out is assigned to be at logic level LOW if Clk_in is determined to be at logic level LOW. Clk_out at logic level LOW indicates that the output voltage Vout is sufficient for performing operations on non volatile memory products.

At step 208, value of output signal Reg_in, from the voltage regulator 102, is stored in a variable X, which is the output of the NAND gate 126. The value of Reg_in can be latched when Clk_in is at logic level HIGH. The variable X stores the latched value of Reg_in. Further, the method proceeds to step 212.

At step 210, value of the output signal Clk_out is assigned to the variable X if Clk_in is at logic level HIGH. Clk_out is further used by the charge pump 108 to regulate the output voltage Vout.

The method stops at step 212.

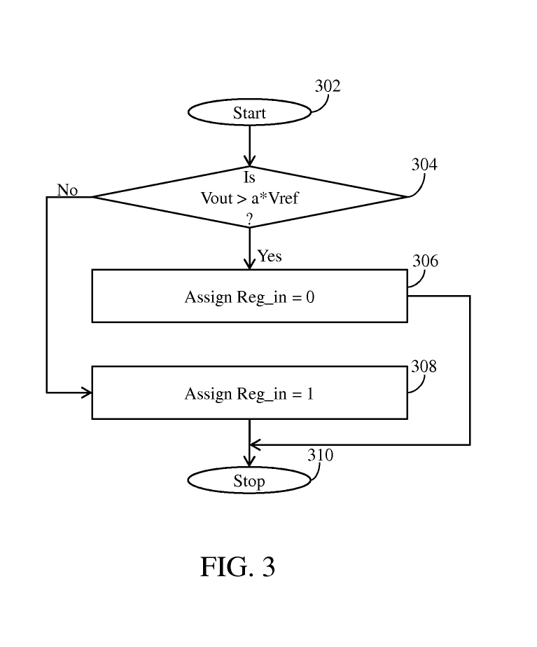

FIG. 3 is a flowchart illustrating a method of functioning of the voltage regulator 102, in accordance with one embodiment.

The method starts at step 302.

At step 304, the voltage regulator 102 determines if the output voltage Vout has a value greater than the target voltage a*Vref. If the value of Vout is greater than a*Vref the method proceeds to step 306. If the value of Vout is lesser than a*Vref the method proceeds to step 308.

At step 306, Reg_in is assigned a logic state of logic level LOW when Vout of the charge pump 108 is greater than the target voltage a*Vref. The output voltage Vout being greater than the target voltage a*Vref indicates that level of Vout is optimum for performing multiple operations on the non-volatile memory products. Reg_in at logic level LOW prevents further increase of the level of Vout.

At step 308, Reg_in is assigned a logic state of logic level HIGH when Vout of the charge pump 108 is lesser than the target voltage a*Vref. The output voltage Vout being lesser than the target voltage a*Vref indicates that the level of Vout is inadequate for performing the multiple operations on the non-volatile memory products. Reg_in at logic level HIGH allows the increase of the level of Vout for performing the multiple operations on the non-volatile memory products.

The method stops at step 310.

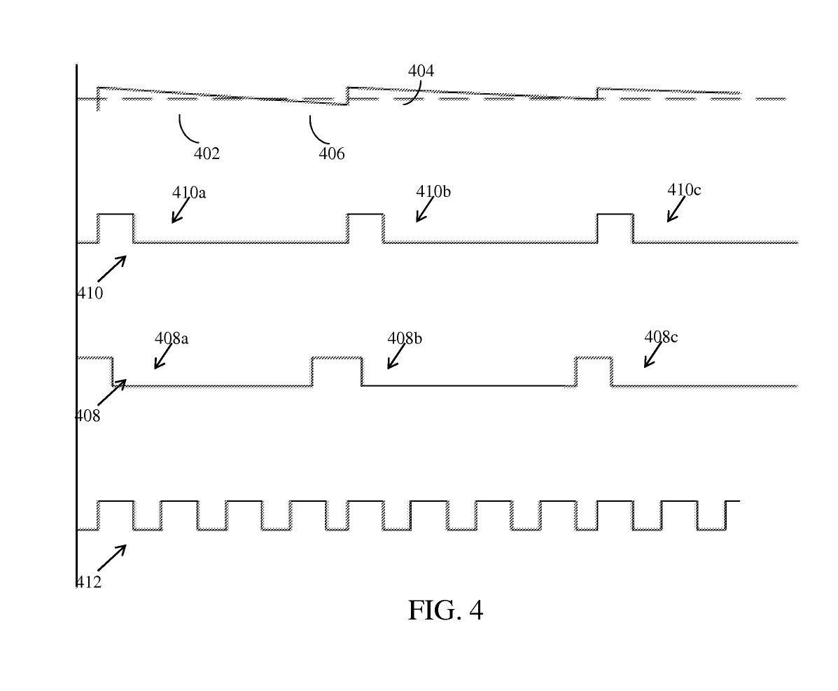

FIG. 4 is a timing diagram illustrating high voltage regulation in the charge pump, for example the charge pump 108, with respect to time, in accordance with one embodiment. A target voltage signal 402 indicates voltage level of a*Vref, which is the target voltage that that needs to be reached by the output voltage Vout, indicated by an output voltage signal 404, of the charge pump 108. The output voltage signal 404 increases until the target voltage is reached. The target voltage can be defined by the charge pump 108. Upon achieving the target voltage, amplitude of the output voltage signal 404 starts decreasing due to charge leakage. When a reference point 406 is reached, level of the output voltage signal 404 falls below level of the target voltage signal 402.

A voltage regulator, for example the voltage regulator 102, generates a Reg_in signal 408 at logic level HIGH at instant 408b when the output voltage signal 404 reaches the reference point 406. Similarly, the Reg_in signal 408 is at logic level HIGH at instant 408a and at instant 408c, when the output voltage signal 404 falls below the target voltage signal 402. The Reg_in signal 408 is communicated to the charge pump 108, which increases the voltage level of the output voltage signal 404.

The Reg_in signal 408 in turn enables a clock gating circuit, for example the clock gating circuit 106, to generate a Clk_out signal 410 at logic level HIGH at instant 410b. The Clk_out signal 410 is generated when a Clk_in signal 412 goes to logic level HIGH for a first time after the Reg_in signal 408 goes to logic level HIGH. Similarly, the Clk_out signal 410 is at logic level HIGH at instant 410a and at instant 410c, when the Clk_in signal 412 goes to logic level HIGH for the first time after the output voltage signal 404 falls below the target voltage signal 402. The charge pump 108 subsequently increases the voltage level of the output voltage signal 404 based on the Clk_out signal 410. The charge pump 108 increases the voltage level until the output voltage signal 404 reaches the target voltage signal 402.

The Clk_in signal 412 is used to clock each operation involved in high voltage and slew rate regulation in the charge pump 108. Since the Clk_out signal 410 can be at logic level HIGH only when the Clk_in signal 412 is at logic level HIGH, the slew rate of the charge pump 108 can be controlled based on the frequency of the Clk_in signal 412.

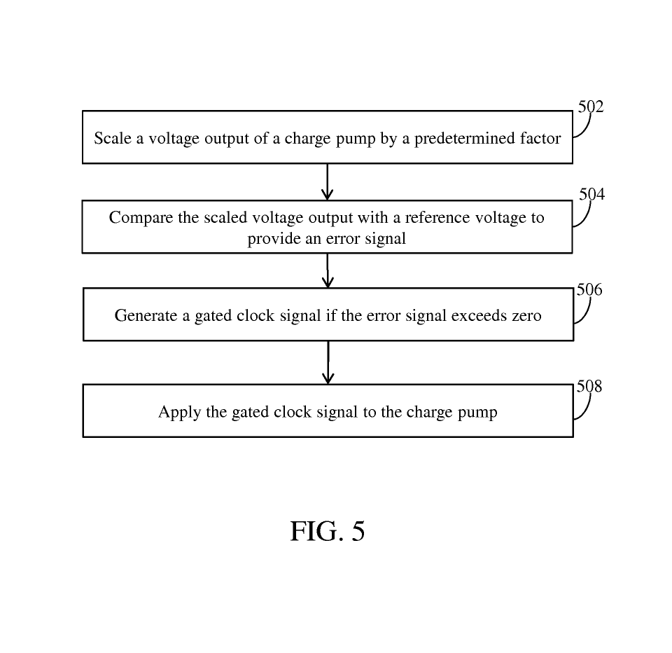

FIG. 5 is a flow diagram illustrating a method of controlling a charge pump, for example the charge pump 108, in accordance with one embodiment.

The method starts at step 502.

At step 502, an output voltage of the charge pump, for example the charge pump 108, is scaled by a predetermined factor, for example ‘a’, as described in conjunction with FIG. 1. Scaling can be performed by dividing the output voltage of the charge pump by the predetermined factor. The scaling is also performed to ensure that the output voltage of the charge pump restrains from experiencing high voltage that leads to destruction of non-volatile memory products.

At step 504, scaled output voltage of the charge pump, obtained as a result of the scaling, is compared with a reference voltage (Vref) to provide an error signal. Comparing of Vref with the scaled output voltage of the charge pump results in generation of the error signal. The error signal is generated when a mismatch between Vref and the scaled output of the charge pump is present. The error signal thereby generated is used for further processing.

At step 506, a gated clock signal is generated if the error signal, generated as a result of the mismatch, exceeds zero. The error signal exceeds zero if the scaled output voltage of the charge pump is less than Vref. The gated clock signal is then generated. The gated clock signal can be generated based on logic state of an output signal Reg_in of a voltage regulator, for example the voltage regulator 102. If the error signal exceeds zero then Reg_in is at a logic level HIGH. The logic state of Reg_in enables the generation of the gated clock signal. The gated clock signal is at logic level HIGH when Reg_in is at logic level HIGH. The logic state of the gated clock signal behaves as a switch that controls regulation of output voltage levels. Further, frequency of the gated clock signal is synchronous to an input signal Clk_in, provided to a clock gating circuit, for example the clock gating circuit 106.

At step 508, the gated clock signal is applied to the charge pump. The gated clock signal when applied to the charge pump, allows the output voltage to increase to a target voltage when the scaled voltage output falls below Vref.

In some embodiments, one or more steps can be implemented using a controller. The controller includes a processor coupled with a bus for processing information. The controller can also include a main memory, for example a random access memory (RAM) or other dynamic storage device, coupled to the bus for storing information required by the processor. The main memory can be used for storing temporary variables or other intermediate information required by the processor. The controller can also include a read only memory (ROM) or other static storage device coupled to the bus for storing static information for the processor. A storage device, for example a magnetic disk or optical disk, can also be provided and coupled to the bus for storing information. The controller can be coupled via the bus to a display for example a cathode ray tube (CRT), a liquid crystal display (LCD) or a light emitting diode (LED) display, and an input device for communicating information and command selections to the processor.

In one embodiment, the techniques are performed by the processor using information included in the main memory. The information can be read into the main memory from another computer-readable medium, for example the storage unit.

The term “computer-readable medium” as used herein refers to any medium that participates in providing data that causes a computer to operate in a specific fashion. In an embodiment implemented using the controller, various computer-readable medium are involved, for example, in providing information to the processor. The computer-readable medium can be a storage media. Storage media includes both non-volatile media and volatile media. Non-volatile media includes, for example, optical or magnetic disks, for example the storage unit. Volatile media includes dynamic memory, for example the memory. All such media must be tangible to enable the information carried by the media to be detected by a physical mechanism that reads the information into a computer.

Common forms of computer-readable medium include, for example a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge.

In another embodiment, the computer-readable medium can be a transmission media including coaxial cables, copper wire and fiber optics, including the wires that include the bus. Transmission media can also take the form of acoustic or light waves, for example those generated during radio-wave and infra-red data communications.

The controller also includes a communication interface coupled to the bus. The communication interface provides a two-way data communication coupling to a network. For example, the communication interface can be a wireless port, Bluetooth port, IrDa port, and wired port. In any such implementation, communication interface sends and receives electrical, electromagnetic or optical signals that carry digital data streams representing various types of information.

A synchronous clock gating circuit, for example the clock gating circuit 106, used in a discrete time feedback system ensures that a charge pump, for example the charge pump 108, operates in known states by removing glitches that violate clock pulse width and duty cycle requirements. The charge pump is hence simpler in design and has a reduced verification time. The charge pump also provides a predetermined and quantized step value for gain.

In the foregoing discussion, the term “coupled or connected” refers to either a direct electrical connection between the devices connected or an indirect connection through intermediary devices.

The foregoing description sets forth numerous specific details to convey a thorough understanding of embodiments of the disclosure. However, it will be apparent to one skilled in the art that embodiments of the disclosure may be practiced without these specific details. Some well-known features are not described in detail in order to avoid obscuring the disclosure. Other variations and embodiments are possible in light of above teachings, and it is thus intended that the scope of disclosure not be limited by this Detailed Description.

What is claimed is:

1. A circuit comprising:
a voltage regulator with a first input in communication with a reference voltage;
a data latch having a signal input coupled to receive an output of the voltage regulator and coupled to receive a clock input from a clock source;
a delay circuit having an input coupled to receive the clock input from the clock source;
a logic gate having a first input coupled with an output of the data latch and a second input coupled with an output of the delay circuit; and
a charge pump having an input coupled with an output of the logic gate and an output coupled with a second input of the voltage regulator, the output of the charge pump providing an output voltage.

2. The circuit as claimed in claim 1, wherein the logic gate comprises a NOR gate.

3. The circuit as claimed in claim 1, wherein the delay circuit comprises two inverter gates in series.

4. The circuit as claimed in claim 1 and further comprising
an inverter gate in series with the clock source.

5. The circuit as claimed in claim 1, wherein the voltage regulator comprises an attenuator, a comparator, and a buffer in series.

6. The circuit as claimed in claim 5, wherein the buffer comprises a Schmitt trigger.

7. The circuit as claimed in claim 5, wherein the attenuator has an input coupled to receive with the output of the charge pump, and an output coupled to a negative input of the comparator.

8. The circuit as claimed in claim 7, wherein the comparator has a positive input in communication with the reference voltage.

9. The circuit as claimed in claim 1, wherein the data latch comprises four NAND gates in a cross-coupled configuration.

10. A method of controlling a charge pump, the method comprising:
scaling an output voltage of the charge pump by a predetermined factor;
comparing scaled output voltage with a reference voltage to provide an error signal;
generating a gated clock signal if the error signal exceeds zero; and
applying the gated clock signal to the charge pump.

11. The method as claimed in claim 10, wherein the error signal is provided by buffering the error signal.

12. The method as claimed in claim 11, wherein buffering the error signal comprises using hysteresis.

13. The method as claimed in claim 10, wherein generating the gated clock signal comprises latching the error signal in a latch under control of a clock signal.

14. The method as claimed in claim 13 and further comprising:
delaying the clock signal, and
gating the error signal in sync with the delayed clock signal.

15. A computer program product stored on a non-transitory computer-readable medium that when executed by a processor, performs a method of controlling a charge pump, comprising:
scaling an output voltage of the charge pump by a predetermined factor;
comparing scaled output voltage with a reference voltage to provide an error signal;
generating a gated clock signal if the error signal exceeds zero; and
applying the gated clock signal to the charge pump.

16. The computer program product as claimed in claim 15, wherein the error signal is provided by buffering the error signal.

17. The computer program product as claimed in claim 16, wherein buffering the error signal comprises using hysteresis.

18. The computer program product as claimed in claim 15, wherein generating the gated clock signal comprises latching the error signal in a latch under control of a clock signal.

19. The computer program product as claimed in claim 18 and further comprising:
delaying the clock signal, and
gating the error signal in sync with the delayed clock signal.

20. A high voltage generation system comprising:
a charge pump that provides an output voltage to a non-volatile memory;
a voltage regulator with a first input in communication with a voltage reference and a second input receiving the output voltage of the charge pump;
a data latch receiving a signal input from an output of the voltage regulator and receiving a clock input from a clock source;
a delay circuit receiving the clock input from the clock source; and
a logic gate with a first input receiving an output from the data latch, a second input receiving an output of the delay circuit, and an output in communication with an input of the charge pump.

21. The high voltage generation system as claimed in claim 20, wherein the high voltage generation system drives a non-volatile memory.

22. The high voltage generation system as claimed in claim 20, wherein the logic gate comprises a NOR gate.

23. The high voltage generation system as claimed in claim 20, wherein the delay circuit comprises two inverter gates in series.

24. The high voltage generation system as claimed in claim 20, wherein the voltage regulator comprises an attenuator, a comparator, and a buffer in series.

25. The high voltage generation system as claimed in claim 24, wherein the buffer comprises a Schmitt trigger.

26. The high voltage generation system as claimed in claim 20, wherein the data latch comprises four NAND gates in a cross-coupled configuration.
